(19) United States
(12) Patent Application Publication
(10) Pub. No.: US 2023/0335863 A1
(43) Pub. Date: Oct. 19, 2023

(54) SECONDARY BATTERY, ELECTRONIC EQUIPMENT, AND ELECTRIC TOOL

(71) Applicant: MURATA MANUFACTURING CO., LTD., Kyoto (JP)

(72) Inventors: Akira OTANI, Kyoto (JP); Aya MATSUZUKA, Kyoto (JP)

(21) Appl. No.: 18/211,955

(22) Filed: Jun. 20, 2023

Related U.S. Application Data
(63) Continuation of application No. PCT/JP2022/001900, filed on Jan. 20, 2022.

(30) Foreign Application Priority Data
Jan. 26, 2021 (JP) 2021-010583

(51) Int. Cl. H01M 50/46; H01M 10/0525; H01M 50/536; H01M 10/0587

(52) U.S. Cl. CPC H01M 50/46; H01M 10/0525; H01M 50/536; H01M 10/0587

(57) ABSTRACT

A positive electrode includes, on a positive electrode foil having a band shape, a positive electrode active material covered part covered with a positive electrode active material layer, and a positive electrode active material uncovered part. A negative electrode includes, on a negative electrode foil having a band shape, a negative electrode active material covered part covered with a negative electrode active material layer, and a negative electrode active material uncovered part extending at least in a longitudinal direction of the negative electrode foil. The positive electrode active material uncovered part is coupled to a positive electrode current collector at one end part of an electrode wound body. The negative electrode active material uncovered part is coupled to a negative electrode current collector at another end part of the electrode wound body. The electrode wound body has one or more flat surfaces, in which the positive electrode active material uncovered part, the negative electrode active material uncovered part, or both are bent toward a central axis of a wound structure to form the one or more flat surfaces, and a groove provided in each of the one or more flat surfaces. When at least a positive electrode side of the electrode wound body is viewed in a section taken along a plane including the central axis, respective end parts of layers of the separator that are located on at least respective opposite sides of an innermost wind side negative electrode are coupled to each other, the innermost wind side negative electrode being a part of the negative electrode that is located on a side of an innermost wind.

### CROSS REFERENCE TO RELATED APPLICATIONS

The present application is a continuation of PCT patent application no. PCT/JP2022/001900, filed on Jan. 20, 2022, which claims priority to Japanese patent application no. JP2021-010583, filed on Jan. 26, 2021, the entire contents of which are incorporated herein by reference.

### BACKGROUND

The present application relates to a secondary battery, electronic equipment, and an electric tool.

Development of lithium ion batteries has expanded to applications that require high output power, including electric tools and vehicles. A lithium ion battery of a cylindrical shape is described.

### SUMMARY

The present application relates to a secondary battery, electronic equipment, and an electric tool.

Depending on a structure of a secondary battery, metal powder coming off a positive electrode current collector (a foil) can come into contact with a negative electrode to cause an internal short circuit. In addition, it is undesirable that the secondary battery be structurally deformed in a process of removing the metal powder. Regarding a lithium ion battery of a cylindrical shape referenced in the Background section, more consideration from such a point of view seems to be necessary and there is thus room for improvement in that, for example, safety of the secondary battery is to be ensured.

The present application relates to providing a secondary battery that suppresses contact of metal powder coming off a positive electrode current collector (a foil) with a negative electrode as much as possible; a secondary battery that suppresses deformation of a separator occurring in a suction process on the metal powder as much as possible; and electronic equipment and an electric tool that each include any of these secondary batteries according to an embodiment.

In an embodiment, a secondary battery includes an electrode wound body, a positive electrode current collector, a negative electrode current collector, and a battery can. The electrode wound body includes a positive electrode having a band shape and a negative electrode having a band shape. The positive electrode and the negative electrode are stacked with a separator interposed therebetween. The battery can contains the electrode wound body, the positive electrode current collector, and the negative electrode current collector.

The positive electrode includes, on a positive electrode foil having a band shape, a positive electrode active material covered part covered with a positive electrode active material layer, and a positive electrode active material uncovered part.

The negative electrode includes, on a negative electrode foil having a band shape, a negative electrode active material covered part covered with a negative electrode active material layer, and a negative electrode active material uncovered part extending at least in a longitudinal direction of the negative electrode foil.

The positive electrode active material uncovered part is coupled to the positive electrode current collector at one of end parts of the electrode wound body.

The negative electrode active material uncovered part is coupled to the negative electrode current collector at another of the end parts of the electrode wound body.

The electrode wound body has one or more flat surfaces, in which the positive electrode active material uncovered part, the negative electrode active material uncovered part, or both are bent toward a central axis of a wound structure to form the one or more flat surfaces, and a groove provided in each of the one or more flat surfaces.

When at least a positive electrode side of the electrode wound body is viewed in a section taken along a plane including the central axis, respective end parts of layers of the separator that are located at least on respective opposite sides of an innermost wind side negative electrode are coupled to each other, the innermost wind side negative electrode being a part of the negative electrode that is located on a side of an innermost wind.

According to an embodiment, it is possible to suppress contact of metal powder coming off the positive electrode current collector (the foil) with the negative electrode as much as possible. Further, it is possible to suppresses deformation of the separator occurring in the suction process on the metal powder as much as possible according to an embodiment. It should be understood that the contents of the present application are not to be construed as being limited by the effects exemplified herein.

### BRIEF DESCRIPTION OF THE FIGURES

FIG. 1 is a sectional view of a lithium ion battery according to an embodiment.

FIG. 2 includes views A and B which are diagrams for describing a positive electrode according to an embodiment.

FIG. 3 includes views A and B which are diagrams for describing a negative electrode according to an embodiment.

FIG. 4 is a diagram illustrating the positive electrode, the negative electrode, and a separator before being wound.

FIG. 5 includes view A which is a plan view of a positive electrode current collector according to an embodiment, and view B which is a plan view of a negative electrode current collector according to an embodiment.

FIG. 6 includes views A to F which are diagrams describing a process of assembling the lithium ion battery according to an embodiment.

FIG. 7 is a diagram for describing a flat surface on a positive electrode side according to an embodiment.

FIG. 8 is a diagram illustrating a section, on the positive electrode side, of the lithium ion battery according to an embodiment.

FIG. 9 is a diagram for describing an end part coupling process according to an embodiment.

FIG. 10 is a diagram for describing the present technology according to an embodiment.

FIG. 11 is a diagram for describing Examples 1 and 2.

FIG. 12 is a diagram for describing Comparative example 1.

FIG. 13 is a coupling diagram for use to describe a battery pack as an application example.

FIG. 14 is a coupling diagram for use to describe an electric tool as an application example.

FIG. 15 is a coupling diagram for use to describe an electric vehicle as an application example.

### DETAILED DESCRIPTION

The present disclosure is described below in further detail including with reference to the drawings according to an embodiment. One or more embodiments described herein are examples of the present disclosure, and the contents of the present disclosure are not limited thereto. It is to be noted that in order to facilitate understanding of description, one or more features including one or more components of the present technology as illustrated in any of the drawings may be enlarged, emphasized, or reduced, or illustration of some portions may be simplified.

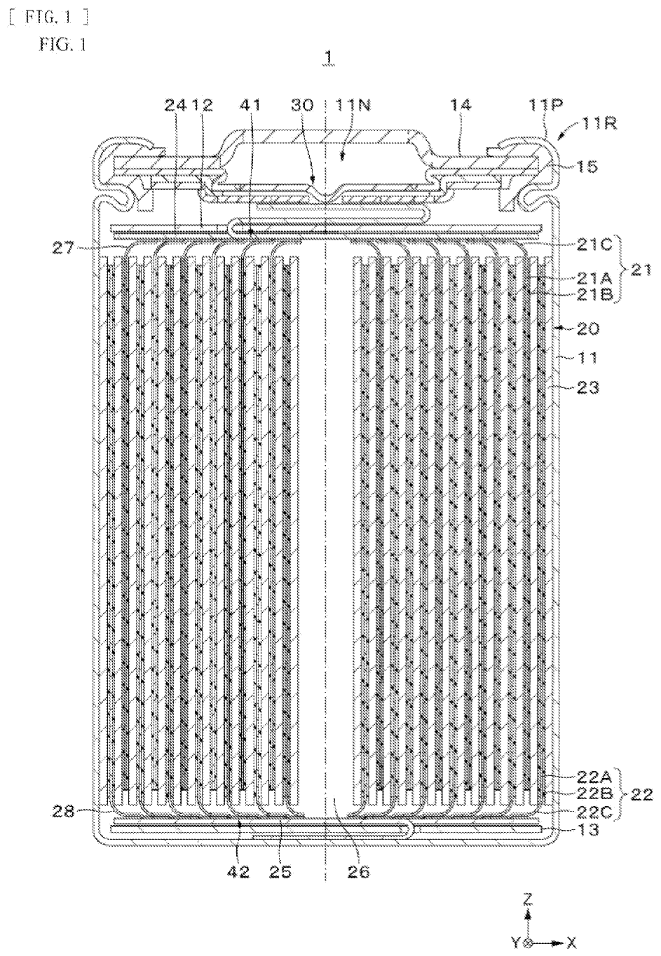

In an embodiment, a lithium ion battery having a cylindrical shape will be described as an example of a secondary battery. A configuration example of a lithium ion battery (a lithium ion battery 1) according to an embodiment will be described with reference to FIGS. 1 to 5. FIG. 1 is a schematic sectional view of the lithium ion battery 1. As illustrated in FIG. 1, the lithium ion battery 1 has a cylindrical shape and includes an electrode wound body 20 contained inside a battery can 11, for example. In the following description, unless otherwise specified, a horizontal direction in the plane of FIG. 1 will be referred to as an X-axis direction, a direction into the plane of FIG. 1 will be referred to as a Y-axis direction, and a vertical direction, i.e., a direction of extension of a central axis (an axis represented by a dot-and-dash line in FIG. 1) of the lithium ion battery 1 in the plane of FIG. 1 will be referred to as a Z-axis direction, as appropriate. The central axis will also be referred to as a winding axis as appropriate.

In a schematic configuration, the lithium ion battery 1 includes the battery can 11 having a cylindrical shape, and also includes, inside the battery can 11, a pair of insulators 12 and 13 and the electrode wound body 20. Note that the lithium ion battery 1 may further include, for example, one or more of devices and members including, without limitation, a thermosensitive resistive device or a PTC device and a reinforcing member, inside the battery can 11.

The battery can 11 is a member that contains mainly the electrode wound body 20. The battery can 11 is, for example, a cylindrical container with one end face open and another end face closed. That is, the battery can 11 has one open end face (an open end face 11N). The battery can 11 includes, for example, one or more of metal materials including, without limitation, iron, aluminum, and alloys thereof. The battery can 11 may have a surface plated with one or more of metal materials including, without limitation, nickel, for example.

The insulators 12 and 13 are disk-shaped plates each having a surface that is substantially perpendicular to a central axis of the electrode wound body 20. The central axis passes through substantially a center of each of end faces of the electrode wound body 20 and is in a direction parallel to the Z-axis in FIG. 1. The insulators 12 and 13 are so disposed as to allow the electrode wound body 20 to be interposed therebetween, for example.

A battery cover 14 and a safety valve mechanism 30 are crimped to the open end face 11N of the battery can 11 via a gasket 15 to thereby provide a crimped structure 11R (a crimp structure). The battery can 11 is thus sealed, with the electrode wound body 20 and other components being contained inside the battery can 11.

The battery cover 14 is a member that closes the open end face 11N of the battery can 11 mainly in the state where the electrode wound body 20 and the other components are contained inside the battery can 11. The battery cover 14 includes, for example, a material similar to the material included in the battery can 11. A middle region of the battery cover 14 protrudes in a +Z direction, for example. A region other than the middle region, that is, a peripheral region, of the battery cover 14 is thus in contact with the safety valve mechanism 30, for example.

The gasket 15 is a member that is mainly interposed between the battery can 11 (a bent part 11P) and the battery cover 14 to thereby seal a gap between the bent part 11P and the battery cover 14. Note that the gasket 15 may have a surface coated with a material such as asphalt, for example.

The gasket 15 includes one or more of insulating materials, for example. The insulating material is not particularly limited in kind. For example, a polymer material such as polybutylene terephthalate (PBT) or polypropylene (PP) may be used as the insulating material. In particular, the insulating material is preferably polybutylene terephthalate. A reason for this is that such a material is able to sufficiently seal the gap between the bent part 11P and the battery cover 14 while electrically separating the battery can 11 and the battery cover 14 from each other.

The safety valve mechanism 30 cancels the sealed state of the battery can 11 and thereby releases a pressure inside the battery can 11, i.e., an internal pressure of the battery can 11 on an as-needed basis, mainly upon an increase in the internal pressure. Examples of a cause of the increase in the internal pressure of the battery can 11 include a gas generated due to a decomposition reaction of an electrolytic solution during charging and discharging.

In the lithium ion battery 1 having a cylindrical shape, a positive electrode 21 having a band shape and a negative electrode 22 having a band shape, which are stacked with a separator 23 interposed therebetween and are wound in a spiral shape, are contained in the battery can 11, being impregnated with the electrolytic solution. The positive electrode 21 includes a positive electrode foil 21A with a positive electrode active material layer 21B provided on one of or each of both surfaces of the positive electrode foil 21A. A material of the positive electrode foil 21A is a metal foil including, for example, aluminum or an aluminum alloy. The negative electrode 22 includes a negative electrode foil 22A with a negative electrode active material layer 22B provided on one of or each of both surfaces of the negative electrode foil 22A. A material of the negative electrode foil 22A is a metal foil including, for example, nickel, a nickel alloy, copper, or a copper alloy. The separator 23 is a porous insulating film. The separator 23 electrically insulates the positive electrode 21 and the negative electrode 22 from each other, and allows for movement of substances including, without limitation, ions and the electrolytic solution.

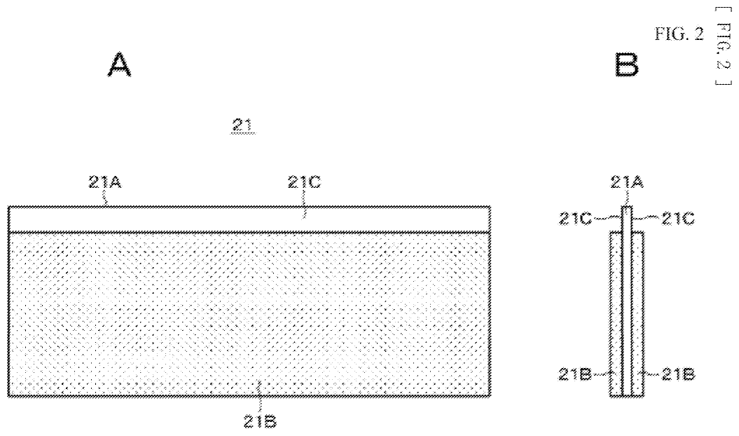

FIG. 2, view A is a front view of the positive electrode 21 before being wound. FIG. 2, view B is a side view of the positive electrode 21 of FIG. 2, view A. The positive electrode 21 includes, at each of one major surface and another major surface of the positive electrode foil 21A, a part (a part shaded with dots) covered with the positive electrode active material layer 21B, and a positive electrode active material uncovered part 21C which is a part not covered with the positive electrode active material layer 21B. Note that in the following description, the part covered with the positive electrode active material layer 21B will be referred to as a positive electrode active material covered part 21B as appropriate. The positive electrode 21 may have a configuration in which the positive electrode active material covered part 21B is provided at one of the major surfaces of the positive electrode foil 21A.

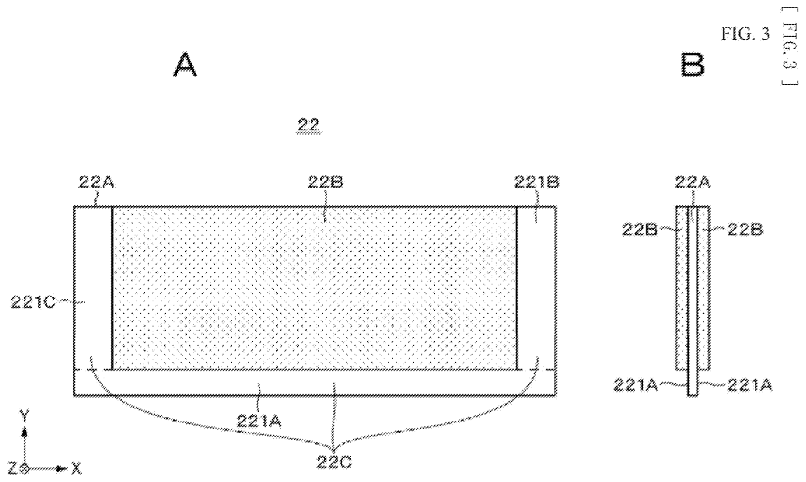

FIG. 3, view A is a front view of the negative electrode 22 before being wound. FIG. 3, view B is a side view of the negative electrode 22 of FIG. 3, view A. The negative electrode 22 includes, at each of one major surface and another major surface of the negative electrode foil 22A, a part (a part shaded with dots) covered with the negative electrode active material layer 22B, and a negative electrode active material uncovered part 22C which is a part not covered with the negative electrode active material layer 22B. Note that in the following description, the part covered with the negative electrode active material layer 22B will be referred to as a negative electrode active material covered part 22B as appropriate. The negative electrode 22 may have a configuration in which the negative electrode active material covered part 22B is provided at one of the major surfaces of the negative electrode foil 22A.

As illustrated in FIG. 3, view A, the negative electrode active material uncovered part 22C includes, for example, a first negative electrode active material uncovered part 221A, a second negative electrode active material uncovered part 221B, and a third negative electrode active material uncovered part 221C. The first negative electrode active material uncovered part 221A extends in a longitudinal direction of the negative electrode 22, i.e., in the X-axis direction in FIG. 3. The second negative electrode active material uncovered part 221B is provided on a beginning side of winding of the negative electrode 22 and extends in a transverse direction of the negative electrode 22, i.e., in the Y-axis direction in FIG. 3, which will also be referred to as a width direction as appropriate. The third negative electrode active material uncovered part 221C is provided on an end side of the winding of the negative electrode 22 and extends in the transverse direction of the negative electrode 22, i.e., in the Y-axis direction in FIG. 3. Note that in FIG. 3, view A, a boundary between the first negative electrode active material uncovered part 221A and the second negative electrode active material uncovered part 221B, and a boundary between the first negative electrode active material uncovered part 221A and the third negative electrode active material uncovered part 221C are each represented by a dashed line.

In the electrode wound body 20 of the lithium ion battery 1 having the cylindrical shape according to the present embodiment, the positive electrode 21 and the negative electrode 22 are laid over each other and wound, with the separator 23 interposed therebetween, in such a manner that the positive electrode active material uncovered part 21C and the first negative electrode active material uncovered part 221A face toward opposite directions.

The electrode wound body 20 has a through hole 26 at a center thereof. Specifically, the through hole 26 is a hole part that develops at substantially a center of a stack in which the positive electrode 21, the negative electrode 22, and the separator 23 are stacked. The through hole 26 is used as a hole into which a rod-shaped welding tool, which will hereinafter be referred to as a welding rod, as appropriate, is to be inserted in a process of assembling the lithium ion battery 1.

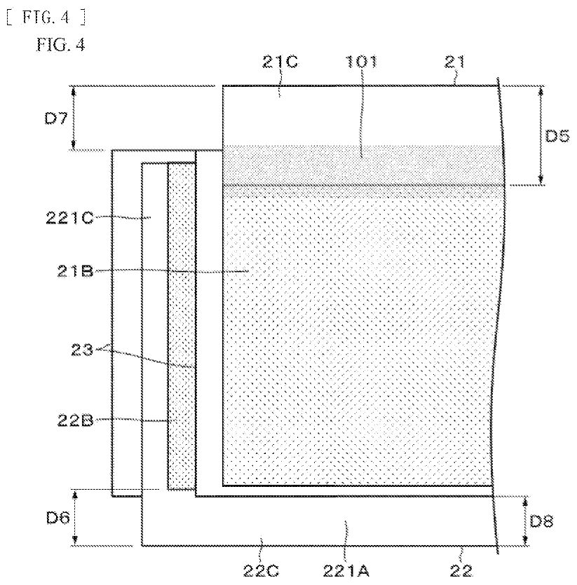

Details of the electrode wound body 20 will be described. FIG. 4 illustrates an example of a pre-winding structure in which the positive electrode 21, the negative electrode 22, and the separator 23 are stacked. The positive electrode 21 further includes an insulating layer 101 (a gray-region part in FIG. 4) covering a boundary between the positive electrode active material covered part 21B (a part lightly shaded with dots in FIG. 4) and the positive electrode active material uncovered part 21C. The insulating layer 101 has a length in the width direction of about 3 mm, for example. All of a region of the positive electrode active material uncovered part 21C opposed to the negative electrode active material covered part 22B with the separator 23 interposed therebetween is covered with the insulating layer 101. The insulating layer 101 has an effect of reliably preventing an internal short circuit of the lithium ion battery 1 when foreign matter enters between the negative electrode active material covered part 22B and the positive electrode active material uncovered part 21C. In addition, the insulating layer 101 has an effect of, in a case where the lithium ion battery 1 undergoes an impact, absorbing the impact and thereby reliably preventing the positive electrode active material uncovered part 21C from bending and short-circuiting with the negative electrode 22.

Here, as illustrated in FIG. 4, a length of the positive electrode active material uncovered part 21C in the width direction is denoted as D5, and a length of the first negative electrode active material uncovered part 221A in the width direction is denoted as D6. In an embodiment, it is preferable that D5>D6. For example, D5=7 (mm), and D6=4 (mm). Where a length of a portion of the positive electrode active material uncovered part 21C protruding from one end in the width direction of the separator 23 is denoted as D7 and a length of a portion of the first negative electrode active material uncovered part 221A protruding from another end in the width direction of the separator 23 is denoted as D8, in an embodiment, it is preferable that D7>D8. For example, D7=4.5 (mm), and D8=3 (mm).

The positive electrode foil 21A and the positive electrode active material uncovered part 21C include aluminum, for example. The negative electrode foil 22A and the negative electrode active material uncovered part 22C include copper, for example. Thus, the positive electrode active material uncovered part 21C is typically softer, that is, lower in Young's modulus, than the negative electrode active material uncovered part 22C. Accordingly, in an embodiment, it is more preferable that D5>D6 and D7>D8. In such a case, when portions of the positive electrode active material uncovered part 21C and portions of the negative electrode active material uncovered part 22C are simultaneously bent with equal pressures from both electrode sides, respective heights of the bent portions as measured from respective ends of the separator 23 may be substantially the same between the positive electrode 21 and the negative electrode 22. In this situation, the portions of the positive electrode active material uncovered part 21C appropriately overlap with each other when bent, which makes it possible to easily couple the positive electrode active material uncovered part 21C and a positive electrode current collector 24 to each other by laser welding in a process of fabricating the lithium ion battery 1. Further, the portions of the negative electrode active material uncovered part 22C appropriately overlap with each other when bent, which makes it possible to easily couple the negative electrode active material uncovered part 22C and a negative electrode current collector 25 to each other by laser welding in the process of fabricating the lithium ion battery 1. Details of the process of fabricating the lithium ion battery 1 will be described later.

In a typical lithium ion battery, for example, a lead for current extraction is welded at one location on each of the positive electrode and the negative electrode. However, such a configuration is not suitable for high-rate discharging because a high internal resistance of the battery results to cause the lithium ion battery to generate heat and become hot during discharging. To address this, in the lithium ion battery 1 according to the present embodiment, the positive electrode current collector 24 is disposed on one end face, i.e., an end face 41, of the electrode wound body 20, and the negative electrode current collector 25 is disposed on another end face, i.e., an end face 42, of the electrode wound body 20. In addition, the positive electrode current collector 24 and the positive electrode active material uncovered part 21C located at the end face 41 are welded to each other at multiple points; and the negative electrode current collector 25 and the negative electrode active material uncovered part 22C (specifically, the first negative electrode active material uncovered part 221A) located at the end face 42 are welded to each other at multiple points. The internal resistance of the lithium ion battery 1 is thereby kept low to allow for high-rate discharging.

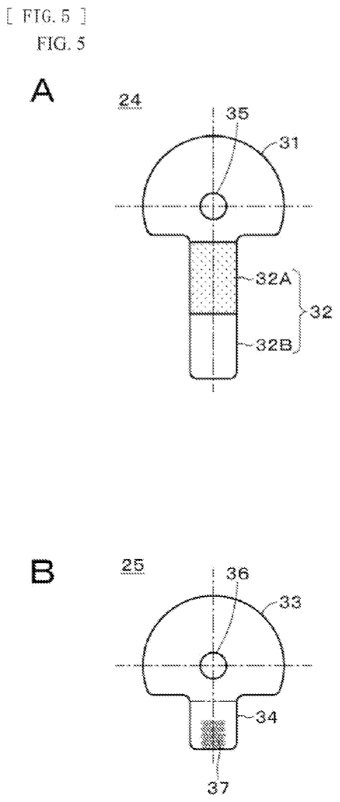

FIG. 5, views A and B illustrate respective examples of the current collectors. FIG. 5, view A illustrates the positive electrode current collector 24. FIG. 5, view B illustrates the negative electrode current collector 25. The positive electrode current collector 24 and the negative electrode current collector 25 are contained in the battery can 11 (see FIG. 1). A material of the positive electrode current collector 24 is a metal plate including, for example, a simple substance or a composite material of aluminum or an aluminum alloy. A material of the negative electrode current collector 25 is a metal plate including, for example, a simple substance or a composite material of nickel, a nickel alloy, copper, or a copper alloy. As illustrated in FIG. 5, view A, the positive electrode current collector 24 has a shape in which a band-shaped part 32 having a rectangular shape is attached to a fan-shaped part 31 having a flat fan shape. The fan-shaped part 31 has a hole 35 at a position near a middle thereof. The position of the hole 35 corresponds to a position of the through hole 26.

A part shaded with dots in FIG. 5, view A represents an insulating part 32A in which an insulating tape or an insulating material is attached or applied to the band-shaped part 32. A part below the dot-shaded part in FIG. 5, view A represents a coupling part 32B to be coupled to a sealing plate that also serves as an external terminal. Note that in a case of a battery structure having no metallic center pin (not illustrated) in the through hole 26, the insulating part 32A may be omitted because there is a low possibility of contact of the band-shaped part 32 with a region of a negative electrode potential. In such a case, it is possible to increase charge and discharge capacities by increasing a width of each of the positive electrode 21 and the negative electrode 22 by an amount corresponding to a thickness of the insulating part 32A.

The negative electrode current collector 25 is similar to the positive electrode current collector 24 in shape, but has a band-shaped part of a different shape. The band-shaped part 34 of the negative electrode current collector of FIG. 5, view B is shorter than the band-shaped part 32 of the positive electrode current collector 24 and includes no portion corresponding to the insulating part 32A. The band-shaped part 34 is provided with circular projections 37 depicted as multiple circles. Upon resistance welding, current is concentrated on the projections 37, causing the projections 37 to melt to thereby cause the band-shaped part 34 to be welded to a bottom of the battery can 11. As with the positive electrode current collector 24, the negative electrode current collector 25 has a hole 36 at a position near a middle of a fan-shaped part 33. The position of the hole 36 corresponds to the position of the through hole 26. The fan-shaped part 31 of the positive electrode current collector 24 and the fan-shaped part 33 of the negative electrode current collector 25, which are each in the shape of a fan, cover respective portions of the end faces 41 and 42. By not covering all of the respective end faces 41 and 42, it is possible to allow the electrolytic solution to smoothly permeate the electrode wound body 20 in assembling the lithium ion battery 1, and it is also possible to facilitate releasing of a gas, which is generated when the lithium ion battery 1 comes into an abnormally hot state or an overcharged state, to the outside of the lithium ion battery 1.

The positive electrode active material layer 21B includes at least a positive electrode material (a positive electrode active material) into which lithium is insertable and from which lithium is extractable, and may further include, for example, a positive electrode binder and a positive electrode conductor. The positive electrode material is preferably a lithium-containing composite oxide or a lithium-containing phosphoric acid compound. The lithium-containing composite oxide has a layered rock-salt crystal structure or a spinel crystal structure, for example. The lithium-containing phosphoric acid compound has an olivine crystal structure, for example.

The positive electrode binder includes a synthetic rubber or a polymer compound. Examples of the synthetic rubber include a styrene-butadiene-based rubber, a fluorine-based rubber, and ethylene propylene diene. Examples of the polymer compound include polyvinylidene difluoride (PVdF) and polyimide.

The positive electrode conductor is a carbon material such as graphite, carbon black, acetylene black, or Ketjen black. Note that the positive electrode conductor may be a metal material or an electrically conductive polymer.

The negative electrode foil 22A configuring the negative electrode 22 is preferably roughened at its surface to achieve improved adherence to the negative electrode active material layer 22B. The negative electrode active material layer 22B includes at least a negative electrode material (a negative electrode active material) into which lithium is insertable and from which lithium is extractable, and may further include, for example, a negative electrode binder and a negative electrode conductor.

The negative electrode material includes a carbon material, for example. The carbon material is graphitizable carbon, non-graphitizable carbon, graphite, low-crystalline carbon, or amorphous carbon. The carbon material has a fibrous shape, a spherical shape, a granular shape, or a flaky shape.

Further, the negative electrode material includes a metal-based material, for example. Examples of the metal-based material include Li (lithium), Si (silicon), Sn (tin), Al (aluminum), Zr (zinc), and Ti (titanium). A metallic element forms a compound, a mixture, or an alloy with another element, and examples thereof include silicon oxide (SiOₓ (0<x≤2)), silicon carbide (SiC), an alloy of carbon and silicon, and lithium titanium oxide (LTO).

The separator 23 is a porous film including a resin, and may be a stacked film including two or more kinds of porous films. Examples of the resin include polypropylene and polyethylene. With the porous film as a base layer, the separator 23 may include a resin layer provided on one of or each of both surfaces of the base layer. A reason for this is that this improves adherence of the separator 23 to each of the positive electrode 21 and the negative electrode 22 and thus suppresses distortion of the electrode wound body 20.

The resin layer includes a resin such as PVdF. In a case of forming the resin layer, a solution including an organic solvent and the resin dissolved therein is applied on the base layer, following which the base layer is dried. Note that the base layer may be immersed in the solution and thereafter the base layer may be dried. From the viewpoint of improving heat resistance and battery safety, the resin layer preferably includes inorganic particles or organic particles. Examples of the kind of the inorganic particles include aluminum oxide, aluminum nitride, aluminum hydroxide, magnesium hydroxide, boehmite, talc, silica, and mica. Alternatively, a surface layer including inorganic particles as a main component and formed by a method such as a sputtering method or an atomic layer deposition (ALD) method may be used instead of the resin layer.

The electrolytic solution includes a solvent and an electrolyte salt, and may further include other materials such as additives on an as-needed basis. The solvent is a nonaqueous solvent such as an organic solvent, or water. The electrolytic solution including a nonaqueous solvent is called a nonaqueous electrolytic solution. Examples of the nonaqueous solvent include a cyclic carbonic acid ester, a chain carbonic acid ester, a lactone, a chain carboxylic acid ester, and a nitrile (mononitrile).

Although a typical example of the electrolyte salt is a lithium salt, the electrolyte salt may include any salt other than the lithium salt. Examples of the lithium salt include lithium hexafluorophosphate (LiPF₆), lithium tetrafluoroborate (LiBF₄), lithium perchlorate (LiClO₄), lithium methanesulfonate (LiCH₃SO₃), lithium trifluoromethanesulfonate (LiCF₃SO₃), and dilithium hexafluorosilicate (Li₂SF₆). These salts may also be used in mixture with each other. From the viewpoint of improving a battery characteristic, it is preferable to use a mixture of LiPF₆ and LiBF₄, in particular. Although not particularly limited, a content of the electrolyte salt is preferably in a range from 0.3 mol/kg to 3 mol/kg both inclusive with respect to the solvent.

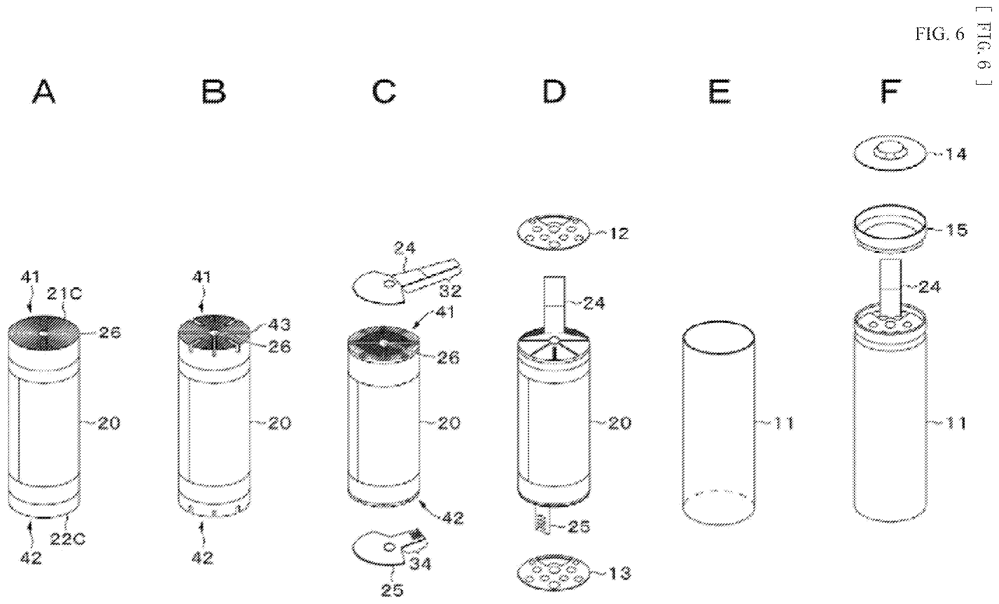

Next, a method of fabricating the lithium ion battery 1 according to the present embodiment will be described with reference to FIG. 6, views A to F. First, the positive electrode active material was applied on the surface of the positive electrode foil 21A having a band shape to thereby form the positive electrode active material covered part 21B, and the negative electrode active material was applied on the surface of the negative electrode foil 22A having a band shape to thereby form the negative electrode active material covered part 22B. At this time, the positive electrode active material uncovered part 21C without the positive electrode active material applied thereon was provided on one end side in the width direction of the positive electrode foil 21A, and the negative electrode foil 22A was provided with the negative electrode active material uncovered part 22C (including the first negative electrode active material uncovered part 221A, the second negative electrode active material uncovered part 221B, and the third negative electrode active material uncovered part 221C) without the negative electrode active material applied thereon. Next, the positive electrode 21 and the negative electrode 22 were subjected to processes including a drying process. Thereafter, the positive electrode 21 and the negative electrode 22 were laid over each other with the separator 23 interposed therebetween in such a manner that the positive electrode active material uncovered part 21C and the negative electrode active material uncovered part 22C faced toward opposite directions, and they were wound in a spiral shape to allow the through hole 26 to develop on the central axis. Thus, the electrode wound body 20 as illustrated in FIG. 6, view A was fabricated.

Thereafter, grooves 43 were formed (produced) as illustrated in FIG. 6, view B (a groove forming process), using an unillustrated groove forming jig provided with a member such as a flat plate at an end face thereof. Specifically, the member such as the flat plate of the groove forming jig was pressed perpendicularly against each of the end faces 41 and 42 to thereby produce the grooves 43 in a portion of each of the end faces 41 and 42. By this method, the grooves 43 were produced to extend radially from the through hole 26. For example, the grooves 43 extend from an outer edge part 27 of the end face 41 to the through hole 26, or from an outer edge part 28 of the end face 42 to the through hole 26. Note that the number and arrangement of the grooves 43 illustrated in FIG. 6B are merely one example, and the illustrated example is thus non-limiting.

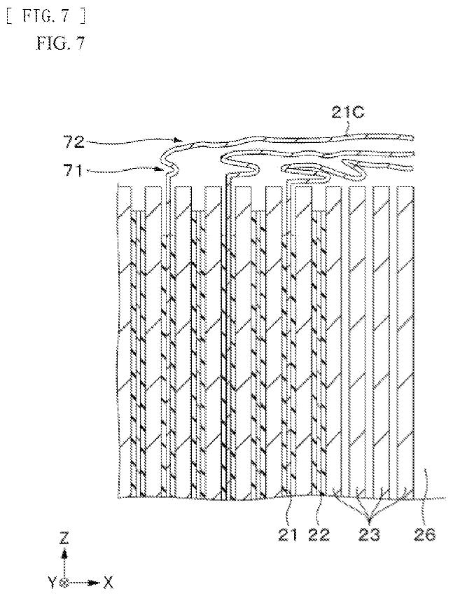

Thereafter, using an unillustrated flat surface forming jig, flat surfaces were formed as in FIG. 6, view C (a flat surface forming process). Specifically, respective flat end faces of the flat surface forming jigs were pressed substantially perpendicularly against the end faces 41 and 42 with equal pressures from both electrode sides simultaneously to thereby apply loads thereto. In such a manner, portions of the positive electrode active material uncovered part 21C were bent toward the central axis of a wound structure to overlap with each other to thereby make the end face 41 into a flat surface, and portions of the negative electrode active material uncovered part 22C (more specifically, portions of the first negative electrode active material uncovered part 221A) were bent toward the central axis of the wound structure to overlap with each other to thereby make the end face 42 into a flat surface. For example, as illustrated in FIG. 7, a bent part 71 is formed in which the bent portions of the positive electrode active material uncovered part 21C overlap with each other. An outer surface of the bent part 71 forms a flat surface 72. Similarly, a bent part (a bent part 81 to be described later) and a flat surface (a flat surface 82 to be described later) are also formed by the bending of the portions of the first negative electrode active material uncovered part 221A.

Thereafter, respective end parts of predetermined layers of the separator were coupled to each other by thermal fusion bonding using, for example, a sheathed heater (an end part coupling process). Details of the end part coupling process will be described later.

Thereafter, metal powder coming off the positive electrode active material uncovered part 21C or the first negative electrode active material uncovered part 221A was suctioned using an unillustrated suction device (a suction process). The coming-off of the metal powder can occur in the groove forming process or the flat surface forming process. For example, the suction is performed with the suction device brought into proximity to or contact with one end face side of the electrode wound body 20, that is, in a state where air is able to flow in from the other end face side through the through hole 26. Thereafter, the suction device is moved to the other end face side to perform suction in a similar manner. The metal powder was removed in this way. Thereafter, the fan-shaped part 31 of the positive electrode current collector 24 was coupled to the end face 41 by laser welding, and the fan-shaped part 33 of the negative electrode current collector 25 was coupled to the end face 42 by laser welding.

Thereafter, as illustrated in FIG. 6, view D, the band-shaped part 32 of the positive electrode current collector 24 and the band-shaped part 34 of the negative electrode current collector 25 were bent, the insulator 12 was attached to the positive electrode current collector 24, and the insulator 13 was attached to the negative electrode current collector 25. The electrode wound body 20 having been assembled in the above-described manner was placed into the battery can 11 illustrated in FIG. 6, view E. Thereafter, the negative electrode current collector 25 was welded to the bottom of the battery can 11 by pressing the unillustrated welding rod thereagainst. The electrolytic solution was injected into the battery can 11, following which the battery can 11 was sealed with the gasket 15 and the battery cover 14, as illustrated in FIG. 6, view F. The lithium ion battery 1 was fabricated as described above.

Note that the insulators 12 and 13 may each be an insulating tape. Further, a method of coupling may be other than laser welding. The grooves 43 remain in the flat surfaces even after the positive electrode active material uncovered part 21C and the first negative electrode active material uncovered part 221A are bent, and a portion of each of the flat surfaces without the grooves 43 is coupled to the positive electrode current collector 24 or the negative electrode current collector 25; however, the grooves 43 may be coupled to a portion of the positive electrode current collector 24 or a portion of the negative electrode current collector 25.

As used herein, the term “flat surface” encompasses not only a completely flat surface but also a surface having some asperities or surface roughness to the extent that it is possible to couple the positive electrode active material uncovered part 21C and the positive electrode current collector 24 to each other and to couple the first negative electrode active material uncovered part 221A and the negative electrode current collector 25 to each other.

To allow for efficient discharging of the lithium ion battery 1, it is necessary to reduce a cell resistance. To reduce the resistance, it is effective to provide a structure in which the current collector is directly welded to the surface configured by the active material uncovered part; however, performing welding on a thin foil can lead to frequent occurrence of a welding defect. To address this, in the lithium ion battery 1 according to the present embodiment, portions of the positive electrode active material uncovered part 21C and portions of the first negative electrode active material uncovered part 221A are bent toward the center. A flat surface in which the bent portions of the positive electrode active material uncovered part 21C overlap with each other and a flat surface in which the bent portions of the first negative electrode active material uncovered part 221A overlap with each other are thereby formed. This helps to improve adhesion to the positive electrode current collector 24 and to the negative electrode current collector 25, allowing for stable welding without perforation.

In order to insert a welding rod when welding the negative electrode current collector 25 to the bottom of the battery can 11, it is necessary to ensure that the through hole 26 has a diameter of a size necessary for the welding rod to be inserted thereinto. By performing the groove forming process or the flat surface forming process while inserting a pin or the like into the through hole 26, it is possible to secure a necessary size as the diameter of the through hole 26. At this time, for example, it becomes more likely that the positive electrode active material uncovered part 21C having been pressed inwardly when forming the flat surface has nowhere to go and can thus be partly broken to generate metal powder. The metal powder can be generated also in the groove forming process. The generated metal powder can come into contact with a part, of the negative electrode included in the electrode wound body 20, that is located on a side of an innermost wind, to thereby cause an internal short circuit. The above-described part of the negative electrode will hereinafter be referred to as an innermost wind side negative electrode, as appropriate. To address the above issue, the lithium ion battery 1 according to the present embodiment employs a configuration that helps to prevent the metal powder generated from the positive electrode active material uncovered part 21C from coming into contact with the negative electrode 22.

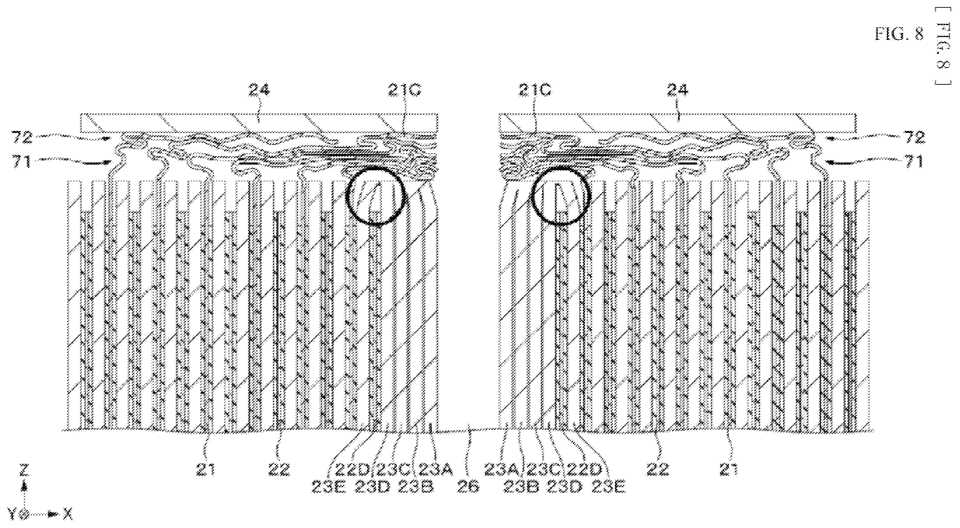

FIG. 8 is a diagram illustrating a portion of at least a positive electrode side of the electrode wound body 20 according to the present embodiment, as viewed in a section taken along a plane including the central axis of the electrode wound body 20. Observation of the section is performed in the following manner, for example.

The lithium ion battery 1 is transversely cut at about half a height thereof and embedded in a resin. Thereafter, the embedded piece of the lithium ion battery 1 is cut along a plane including the central axis of the lithium ion battery 1. The section may thereafter be observed with a microscope. Observation of a section of a negative electrode side of the electrode wound body 20 may also be performed in a similar manner. Note that the positive electrode side of the electrode wound body 20 refers to a region including the end face 41, out of the two opposite end faces of the electrode wound body 20 having a substantially cylindrical shape. The negative electrode side of the electrode wound body 20 refers to a region including the end face 42, out of the two opposite end faces of the electrode wound body 20 having the substantially cylindrical shape.

As illustrated in FIG. 8, the bent part 71 and the flat surface 72 are formed by the bent portions of the positive electrode active material uncovered part 21C. The flat surface 72 is welded to the positive electrode current collector 24. In the lithium ion battery 1 according to the present embodiment, a peripheral surface of the through hole 26 is configured by a separator 23A, for example. In other words, the separator 23A is located on the innermost wind side of the electrode wound body 20. On the separator 23A, separators 23B, 23C, and 23D are stacked toward an outer side (in the X-axis direction in FIG. 8). The innermost wind side negative electrode 22D is located on an outer side of the separator 23D. A separator 23E is located on an outer side of the innermost wind side negative electrode 22D.

In the lithium ion battery 1, as indicated in portions each circled with a thick solid line in FIG. 8, respective end parts (i.e., respective end parts on the positive electrode side) of layers of the separator (i.e., the separators 23D and 23E in this example) that are located at least on respective opposite sides of the innermost wind side negative electrode 22D are coupled to each other. Examples of a method of coupling include thermal fusion bonding using a heater. The innermost wind side negative electrode 22D is thereby covered with the separators 23D and 23E coupled to each other.

As described above, the coming-off of the metal powder from the positive electrode active material uncovered part 21C is likely to occur in the vicinity of an inner side of the bent part 71. In the present embodiment, the innermost wind side negative electrode 22D is covered with the separators 23D and 23E, which helps to prevent contact between the metal powder and the innermost wind side negative electrode 22D, thus helping to prevent the occurrence of an internal short circuit due to contact between the metal powder and the innermost wind side negative electrode 22D.

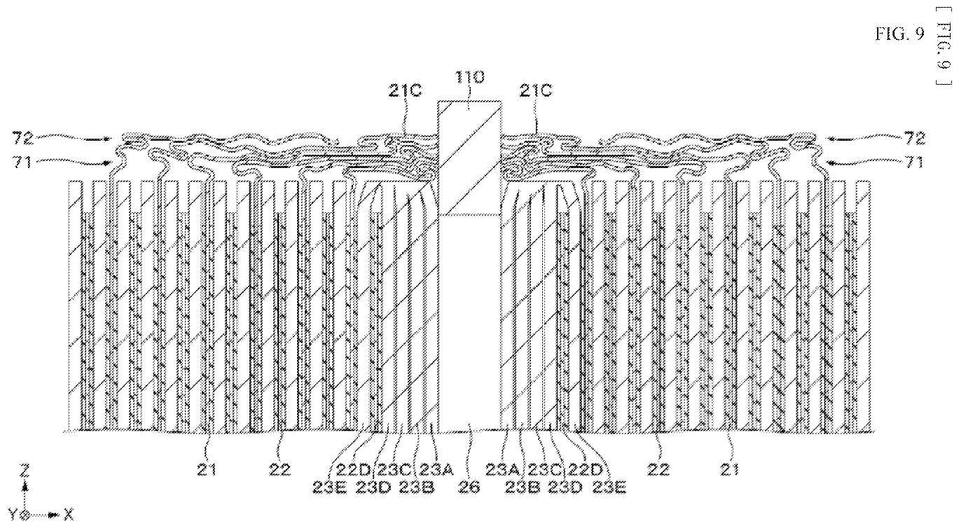

An example of a method of coupling the end parts will be described. As illustrated in FIG. 9, a rod-shaped heater (e.g., a sheathed heater) 110 is inserted into the through hole 26 of the electrode wound body 20. For example, the heater 110 is inserted from the flat surface 72 to 1.5 to 3.0 mm below. Thereafter, the heater 110 is energized to cause a temperature of the heater 110 to increase to a range from 120° C. to 200° C. both inclusive. The heater 110 having been energized heats and melts the separators 23A to 23E. A heating time is set to a range from about one second to about 10 seconds. Thereafter, the heater 110 is taken out of the through hole 26, and the molten separators 23A to 23E are cooled to be cured. The separators 23D and 23E are thereby thermal- fusion-bonded to each other. Note that this method causes also the separators 23A to 23C located on an inner side relative to the separator 23D to melt. Accordingly, as illustrated in FIGS. 8 and 9, the respective end parts of the separators 23A to 23E are coupled to each other by being thermal-fusion-bonded to each other.

Note that it is not necessary that any layers of the separator located on the outer side relative to the separator 23E be thermal-fusion-bonded to each other. A reason for this is as follows. When the positive electrode active material uncovered part 21C is bent toward the center, a bending force is applied also to the separator 23 (any layers of the separator located on the outer side relative to the separator 23E), and accordingly, the end part of the separator 23 is inclined inwardly. The inclined end part of the separator 23 covers the negative electrode 22 to prevent entry of the metal powder. However, neither the positive electrode 21 nor the negative electrode 22 is present on either side of each of the separators 23A to 23D. This makes it difficult for the separators 23A to 23D (particularly the separator 23D) to be stable in position, thus bringing the separators 23A to 23D (particularly the separator 23D) into a relatively free state. Accordingly, it becomes difficult for a space between the innermost wind side negative electrode 22D and the positive electrode active material uncovered part 21C to be covered with the separator such as the separator 23E, which makes it more likely that the metal powder can reach the innermost wind side negative electrode 22D. In the present embodiment, as described above, at least the separator 23D and the separator 23E are thermal-fusion-bonded to each other. This allows for shielding a portion where entry of the metal powder is highly likely. Furthermore, the thermal fusion bonding is performed only on minimum parts, which helps to prevent the fabrication process of the lithium ion battery 1 from increasing in complexity.

The present embodiment makes it possible to achieve the following effects, for example.

By causing the layers of the separator (the separators 23D and 23E) that are located at least on the respective opposite sides of the innermost wind side negative electrode 22D to be thermal-fusion-bonded to each other in such a manner as to cover the innermost wind side negative electrode 22D, it is possible to prevent entry of the metal powder into the innermost wind side negative electrode 22D. Accordingly, it is possible to prevent the occurrence of an internal short circuit due to contact between the innermost wind side negative electrode 22D and the metal powder.

During fabrication of the lithium ion battery, the negative electrode active material can sometimes peel off the negative electrode active material covered part 22B on the beginning side of winding of the electrode wound body 20, i.e., an end side in the longitudinal direction of the positive electrode or the negative electrode located in the innermost wind of the electrode wound body 20, when the edge of a thin flat plate or the like (having a thickness of 0.5 mm, for example) is pressed perpendicularly against each of the end faces 41 and 42, that is, when the process illustrated in FIG. 6, view B is performed. A possible cause of the peeling is stress generated upon pressing the thin flat plate or the like against the end face 42. The negative electrode active material having peeled off can enter the inside of the electrode wound body 20 and can thereby cause an internal short circuit. According to the present embodiment, the provision of the second negative electrode active material uncovered part 221B and the third negative electrode active material uncovered part 221C helps to prevent the peeling of the negative electrode active material, thereby helping to prevent the occurrence of the internal short circuit. Such an effect is achievable even with a configuration in which only either the second negative electrode active material uncovered part 221B or the third negative electrode active material uncovered part 221C is provided; however, it is preferable that both be provided.

On the end side of the winding of the electrode wound body 20, the negative electrode 22 may have a region of the negative electrode active material uncovered part 22C at a major surface facing away from the positive electrode active material covered part 21B. A reason for this is that even if the negative electrode active material covered part 22B is present at the major surface facing away from the positive electrode active material covered part 21B, its contribution to charging and discharging is considered to be low. The region of the negative electrode active material uncovered part 22C preferably falls within a range from ¾ winds to 5/4 winds, both inclusive, of the electrode wound body 20. In this case, owing to the absence of the negative electrode active material covered part 22B that is low in contribution to charging and discharging, it is possible to make an initial capacity higher with respect to the same volume of the electrode wound body 20.

According to the present embodiment, in the electrode wound body 20, the positive electrode 21 and the negative electrode 22 are laid over each other and wound in such a manner that the positive electrode active material uncovered part 21C and the first negative electrode active material uncovered part 221A face toward opposite directions. Thus, the positive electrode active material uncovered part 21C is localized to the end face 41, and the first negative electrode active material uncovered part 221A is localized to the end face 42 of the electrode wound body 20. The positive electrode active material uncovered part 21C and the first negative electrode active material uncovered part 221A are bent to make the end faces 41 and 42 into flat surfaces. The direction of bending is from the outer edge part 27 of the end face 41 toward the through hole 26, or from the outer edge part 28 of the end face 42 toward the through hole 26. Portions of the active material uncovered part that are located in adjacent winds in a wound state are bent and overlap with each other. By making the end face 41 into a flat surface, it is possible to achieve better contact between the positive electrode active material uncovered part 21C and the positive electrode current collector 24; and by making the end face 42 into a flat surface, it is possible to achieve better contact between the first negative electrode active material uncovered part 221A and the negative electrode current collector 25. Further, the configuration in which the end faces 41 and 42 are made into flat surfaces by bending makes it possible for the lithium ion battery 1 to achieve reduced resistance.

It may seem to be possible to make the end faces 41 and 42 into flat surfaces by bending the positive electrode active material uncovered part 21C and the first negative electrode active material uncovered part 221A; however, without any processing in advance of bending, creases or voids (gaps or spaces) can develop in the end faces 41 and 42 upon bending, thus making it difficult for the end faces 41 and 42 to be flat surfaces. Here, “creases” and “voids” are unevenness that can develop in the positive electrode active material uncovered part 21C and the first negative electrode active material uncovered part 221A having been bent, resulting in non-flat portions of the end faces 41 and 42. In the present embodiment, the grooves 43 are formed in advance in radial directions from the through hole 26 on each of the end face 41 side and the end face 42 side. The presence of the grooves 43 helps to prevent the creases and voids from developing, and thereby helps to achieve increased flatness of the end faces 41 and 42. Note that although either the positive electrode active material uncovered part 21C or the first negative electrode active material uncovered part 221A may be bent, it is preferable that both be bent.

The present disclosure will be described in further detail according to an embodiment. Note that unless otherwise specified, the description having been made above is also applicable. Features including components of the present technology that are the same as or similar to the features including components described above are denoted by the same reference signs, and redundant descriptions are thus omitted as appropriate.

A lithium ion battery (a lithium ion battery 1A) according to an embodiment includes the electrode wound body 20, as with the lithium ion battery 1. The electrode wound body 20 includes, on an inner side of the innermost wind side negative electrode 22D, multiple layers of the separator, i.e., the separators 23A to 23D, including the separator 23D that is coupled to the separator 23E on the positive electrode side.

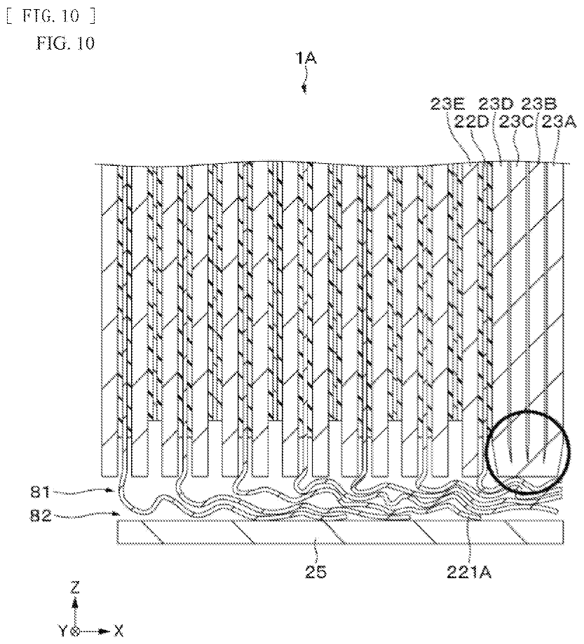

FIG. 10 is a diagram illustrating the negative electrode side of the electrode wound body 20 of the lithium ion battery 1A as viewed in a section similar to that in the first embodiment. As illustrated in FIG. 10, the bent part 81 is formed by the bending of the portions of the first negative electrode active material uncovered part 221A. An outer surface of the bent part 81 forms the flat surface 82. On the negative electrode side, respective end parts of the multiple layers of the separator (the separators 23A to 23D) located on the inner side of the innermost wind side negative electrode 22D are coupled to each other. On the negative electrode side, the separator 23E located on the outer side of the innermost wind side negative electrode 22D is coupled to none of the separators 23A to 23D. A thermal fusion bonding method similar to that in the first embodiment may be employed. In this case, although the separator 23E can also melt, the first negative electrode active material uncovered part 221A of the innermost wind side negative electrode 22D interposed between the separators 23D and 23E prevents the separators 23D and 23E from being thermal-fusion-bonded to each other.

In the lithium ion battery 1A according to an embodiment, the respective end parts of the separators 23A to 23E are thermal-fusion-bonded to each other on the positive electrode side. Further, on the negative electrode side, the respective end parts of the separators 23A to 23D are thermal-fusion-bonded to each other. Owing to the multiple layers of the separator 23 being thermal-fusion-bonded to each other at their respective end parts on the positive electrode side and at their respective end parts on the negative electrode side, improved strength is achieved as compared with a single-layer separator 23. This helps to prevent the separator 23 from being deformed when the suction process is performed, thus helping to suppress deformation of the electrode wound body 20 as much as possible. Furthermore, the above-described configuration helps to prevent the separator 23 from being suctioned into by the suction device.

In the following, the present disclosure will be described in further detail including with reference to Examples and a comparative example in which the lithium ion batteries 1 fabricated in the above-described manner were used to evaluate a process defect rate and a poor open circuit voltage rate according to an embodiment. Note that the present disclosure is not limited to Examples described herein.

For each of Examples and the comparative example described below, a battery size was set to 21700 (21 mm in diameter and 70 mm in height), and the electrode wound body 20 was fabricated with a length of the negative electrode active material covered part 22B in the width direction set to 62 mm, a length of the separator 23 in the width direction set to 64 mm, a clearance between the positive electrode active material covered part 21B and the negative electrode active material covered part 22B set to 1.5 mm, and a clearance between the negative electrode active material covered part 22B and the separator 23 set to 1.5 mm. The separator 23 was placed to cover all of regions of the positive electrode active material covered part 21B and the negative electrode active material covered part 22B. The length of the positive electrode active material uncovered part 21C in the width direction was set to 5 mm. The number of the grooves 43 was set to eight, and the eight grooves were arranged at substantially equal angular intervals.

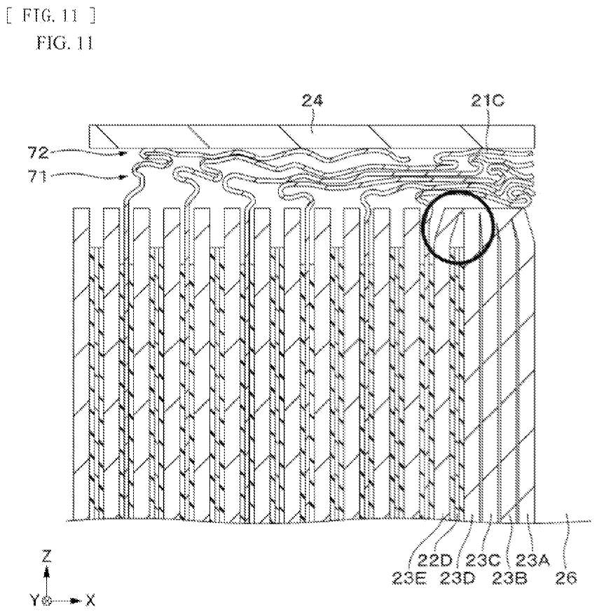

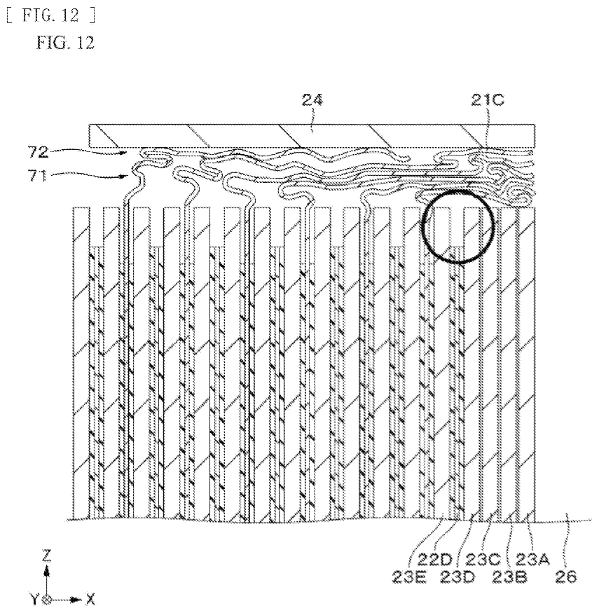

FIG. 11 is a diagram corresponding to Example 1. FIGS. 10 and 11 are diagrams corresponding to Example 2. FIG. 12 is a diagram corresponding to Comparative example 1.

### EXAMPLE 1

The lithium ion battery 1 was fabricated through the above-described process. In this case, in the end part coupling process, a sheathed heater was inserted into the through hole 26 to a depth of 2 mm on the positive electrode side. Heating was performed at 150° C. for three seconds to cause the respective end parts of layers of the separator (the separators 23A to 23E), including those located on respective opposite sides with the innermost wind side negative electrode 22D interposed therebetween, to be coupled to each other by thermal fusion bonding (see FIG. 11).

### EXAMPLE 2

In the end part coupling process of Example 2, on the negative electrode side, the sheathed heater was inserted into the through hole 26 to the depth of 2 mm and heating was performed at 150° C. for three seconds to thereby couple the respective end parts of the separators 23A to 23D by thermal fusion bonding. Except for the above differences, the lithium ion battery 1 was fabricated in a manner similar to that in Example 1 (see FIGS. 10 and 11).

### Comparative Example 1

In Comparative example 1, no end part coupling process was performed and no end parts of layers of the separator 23 were coupled to each other on either of the positive electrode side and the negative electrode side (see FIG. 12). Except for the above differences, the lithium ion battery 1 was fabricated in a manner similar to that in Example 1.

Examples 1 and 2 and Comparative example 1 were evaluated in terms of the process defect rate and the poor open circuit voltage rate.

### (Method of Determining Process Defect Rate)

The process defect rate was evaluated in the following manner. For the purpose of suctioning metal powder, suction was performed at a flow rate of 60 L/min for five seconds on the electrode wound body 20 after shaping, with a suction device brought into complete contact with the end face on the negative electrode side of the electrode wound body 20.

The lithium ion battery 1 in which the through hole 26 was completely blocked with any of layers of the separator 23 located on an inner wind side was judged as being defective by visual inspection. The process defect rate was calculated by dividing the number of the lithium ion batteries 1 with blockage of the through holes 26 by the number of the lithium ion batteries 1 tested.

### (Method of Determining Poor Open Circuit Voltage Rate)

The lithium ion battery 1 having been fabricated was charged with a constant current of 500 mA and a constant voltage in an environment at 25° C. up to a maximum voltage of 4.2 V.

Thereafter, a voltage within one hour was measured as a reference voltage, and a second voltage measurement was performed after two weeks. The lithium ion battery 1 with a voltage drop of 50 mV or more at the second voltage measurement relative to the reference voltage was judged as having a poor open circuit voltage.

The poor open circuit voltage rate was calculated as follows: (number of lithium ion batteries 1 with poor open circuit voltage/number of lithium ion batteries 1 tested)×100.

(Method of Examining Coupling between Separator End Parts)

The electrode wound body 20 was taken out of the lithium ion battery having been completely discharged, and was disassembled. On the positive electrode side, it was examined whether at least the separators 23D and 23E were so coupled to each other as to envelop the innermost wind side negative electrode 22D. On the negative electrode side, it was examined whether multiple layers of the separator located on a central axis side relative to the innermost wind side negative electrode 22D were coupled to each other in part.

A hundred lithium ion batteries 1 to be tested were fabricated for each of respective configurations of Examples 1 and 2 and Comparative example 1, and were subjected to evaluation. The results are given in Table 1 below.

TABLE 1

| | | Coupling between end parts | | | |
|---|---|---|---|---|---|
| | | of layers of separator | | | Poor open |
| | Corresponding | Positive | Negative | Process defect | circuit voltage |
| | figure | electrode side | electrode side | rate [%] | rate [%] |
| Example 1 | FIG. 11 | Present | Absent | 3 | 2 |
| Example 2 | FIG. 10 and | Present | Present | 0 | 2 |
| | FIG. 11 | | | | |
| Comparative | FIG. 12 | Absent | Absent | 8 | 6 |
| example 1 | | | | | |

In Example 1, the process defect rate was 3%, being improved relative to the process defect rate in Comparative example 1 (8%) having no coupling between the end parts. A possible reason for this is that coupling the respective end parts of the separators 23A to 23E to each other increased strength and reduced the occurrence of blockage of the through hole 26 caused by deformation of any of the layers of the separator 23 located on the inner wind side upon suction of the metal powder.

Further, in Example 1, the poor open circuit voltage rate was 2%, being improved relative to the poor open circuit voltage rate in Comparative example 1 (6%) having no coupling between the end parts. A possible reason for this is that the protection provided to the innermost wind side negative electrode 22D helped to prevent metal powder generated from the positive electrode active material uncovered part 21C upon shaping of the electrode wound body 20 from coming into contact with the innermost wind side negative electrode 22D, and thus contributed to the reduction in the poor open circuit voltage rate.

In Example 2, the process defect rate was 0%, being improved relative to the process defect rate in Comparative example 1 (8%) having no coupling between the end parts, and further relative to the process defect rate in Example 1 (3%). A possible reason for this is that coupling the respective end parts of the layers of the separator to each other on both of the positive electrode side and the negative electrode side increased strength and further reduced the occurrence of blockage of the through hole 26 caused by deformation of any of the layers of the separator 23 located on the inner wind side upon suction of the metal powder.

Further, in Example 2, the poor open circuit voltage rate was 2%, being improved relative to the poor open circuit voltage rate in Comparative example 1 (6%) having no coupling between the end parts. A possible reason for this is that, as with Example 1, the protection provided to the innermost wind side negative electrode 22D helped to prevent metal powder generated from the positive electrode active material uncovered part 21C upon shaping of the electrode wound body 20 from coming into contact with the innermost wind side negative electrode 22D, and thus contributed to the reduction in the poor open circuit voltage rate.

In Comparative example 1, the process defect rate was as high as 8%. A possible reason for this is that because the end parts of the layers of the separator were not coupled to each other on either of the positive electrode side and the negative electrode side, any of the layers of the separator 23 located on the inner wind side was deformed to block the through hole 26 upon suction of the metal powder in a larger number of cases.

Further, in Comparative example 1, the poor open circuit voltage rate was as high as 6%. A possible reason for this is that because the innermost wind side negative electrode 22D was not covered, metal powder generated from the positive electrode active material uncovered part 21C upon shaping of the electrode wound body 20 came into contact with the innermost wind side negative electrode 22D to cause an internal short circuit in a larger number of cases.

Based upon the above, each of the configurations presented in Examples 1 and 2 is considered to be a preferable configuration of the lithium ion battery 1.

Although one or more embodiments of the present disclosure have been described herein, the contents of the present disclosure are not limited thereto, and various modifications may be made according to an embodiment.

The foregoing embodiments each have a configuration in which the separator on the inner wind side includes a stack of four layers of separator (the separators 23A to 23D); however, the number of layers of the separator may be one or any plural number other than four.

The foregoing embodiments each preferably have a configuration provided with the second negative electrode active material uncovered part 221B and the third negative electrode active material uncovered part 221C; however, the present technology is applicable also to a lithium ion battery without those negative electrode active material uncovered parts.

In the foregoing embodiments, thermal fusion bonding is employed as an example of the method of coupling. However, the method of coupling may be any of different welding methods or bonding by means of, for example, an adhesive.

Although the number of the grooves 43 is eight in Examples and the comparative example, any other number may be chosen. Although the battery size chosen is 21700 (21 mm in diameter and 70 mm in height), the battery size may be 18650 (18 mm in diameter and 65 mm in height) or any other size.

The fan-shaped parts 31 and 33 in the embodiments may each have a shape other than the fan shape.

The present technology is applicable to a lithium ion battery and to any suitable battery other than a lithium ion battery, and a battery having a cylindrical shape and to any battery having a suitable shape other than a cylindrical shape, such as a laminated battery, a prismatic battery, a coin-type battery, or a button-type battery. In such a case, the shape of the “end face of the electrode wound body” is not limited to a circular shape, and may be any of other shapes including, without limitation, a rectangular shape, an elliptical shape, and an elongated shape. Further, the present technology is implementable also as a method of manufacturing a battery.

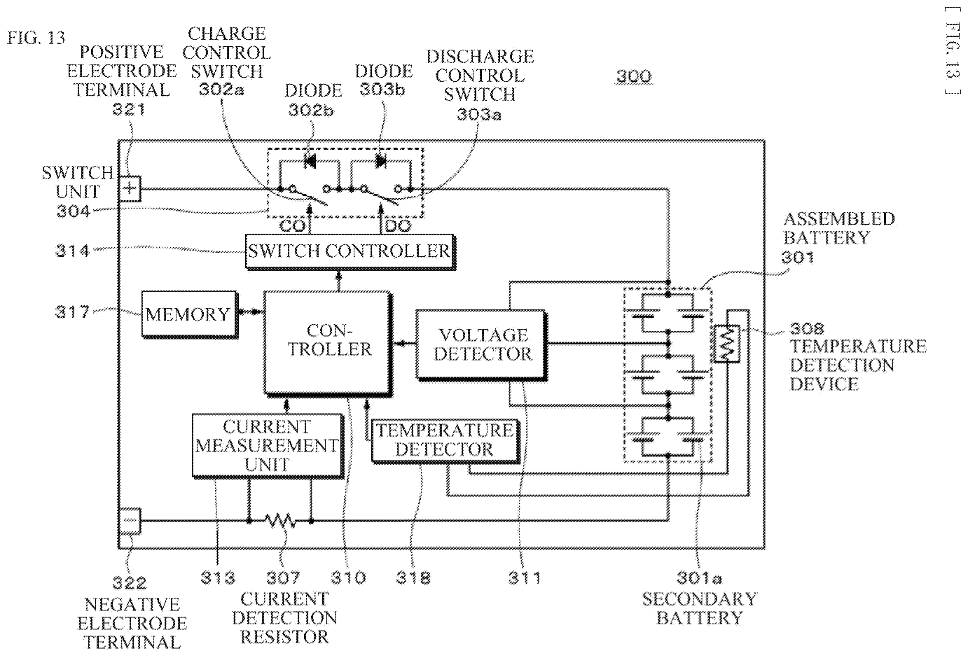

FIG. 13 is a block diagram illustrating a circuit configuration example where the secondary battery according to an embodiment including Examples is applied to a battery pack 300. The battery pack 300 includes an assembled battery 301, a switch unit 304, a current detection resistor 307, a temperature detection device 308, and a controller 310. The switch unit 304 includes a charge control switch 302a and a discharge control switch 303a. The controller 310 controls each device. Further, the controller 310 is able to perform charge and discharge control upon abnormal heat generation, and to perform calculation and correction of a remaining capacity of the battery pack 300. The battery pack 300 includes a positive electrode terminal 321 and a negative electrode terminal 322 that are couplable to a charger or electronic equipment for charging and discharging.

The assembled battery 301 includes multiple secondary batteries 301a coupled in series or in parallel. FIG. 13 illustrates an example case in which six secondary batteries 301a are coupled in a two parallel coupling and three series coupling (2P3S) configuration. The secondary battery according to an embodiment is applicable to the secondary battery 301a.

A temperature detector 318 is coupled to the temperature detection device 308 (for example, a thermistor). The temperature detector 318 measures a temperature of the assembled battery 301 or the battery pack 300, and supplies the measured temperature to the controller 310. A voltage detector 311 measures a voltage of the assembled battery 301 and a voltage of each of the secondary batteries 301a included therein, performs A/D conversion on the measured voltages, and supplies the converted voltages to the controller 310. A current measurement unit 313 measures currents using the current detection resistor 307, and supplies the measured currents to the controller 310.

A switch controller 314 controls the charge control switch 302a and the discharge control switch 303a of the switch unit 304 based on the voltages and the currents respectively supplied from the voltage detector 311 and the current measurement unit 313. When the voltage of any of the secondary batteries 301a becomes higher than or equal to an overcharge detection voltage or becomes lower than or equal to an overdischarge detection voltage, the switch controller 314 transmits a turn-off control signal to the switch unit 304 to thereby prevent overcharging or overdischarging. The overcharge detection voltage is, for example, 4.20 V±0.05 V. The overdischarge detection voltage is, for example, 2.4 V±0.1 V.

After the charge control switch 302a or the discharge control switch 303a is turned off, charging or discharging is enabled only through a diode 302b or a diode 303b. Semiconductor switches such as MOSFETs are employable as these charge and discharge control switches. Note that although the switch unit 304 is provided on a positive side in FIG. 13, the switch unit 304 may be provided on a negative side.

A memory 317 includes a RAM and a ROM. Numerical values including, for example, battery characteristic values, a full charge capacity, and a remaining capacity calculated by the controller 310 are stored and rewritten therein.

The secondary battery according to an embodiment including Examples described herein is mountable on equipment such as electronic equipment, electric transport equipment, or a power storage apparatus, and is usable to supply electric power.

Examples of the electronic equipment include laptop personal computers, smartphones, tablet terminals, personal digital assistants (PDAs) (mobile information terminals), mobile phones, wearable terminals, digital still cameras, electronic books, music players, game machines, hearing aids, electric tools, televisions, lighting equipment, toys, medical equipment, and robots. In addition, for example, electric transport equipment, power storage apparatuses, and electric unmanned aerial vehicles, which will be described later, may also be included in the electronic equipment in a broad sense.

Examples of the electric transport equipment include electric automobiles (including hybrid electric automobiles), electric motorcycles, electric-assisted bicycles, electric buses, electric carts, automated guided vehicles (AGVs), and railway vehicles. Examples of the electric transport equipment further include electric passenger aircrafts and electric unmanned aerial vehicles for transportation. The secondary battery according to an embodiment is used not only as a driving power source for the foregoing electric transport equipment but also as, for example, an auxiliary power source or an energy-regenerative power source therefor.

Examples of the power storage apparatuses include a power storage module for commercial or household use, and a power storage power source for architectural structures including residential houses, buildings, and offices, or for power generation facilities.

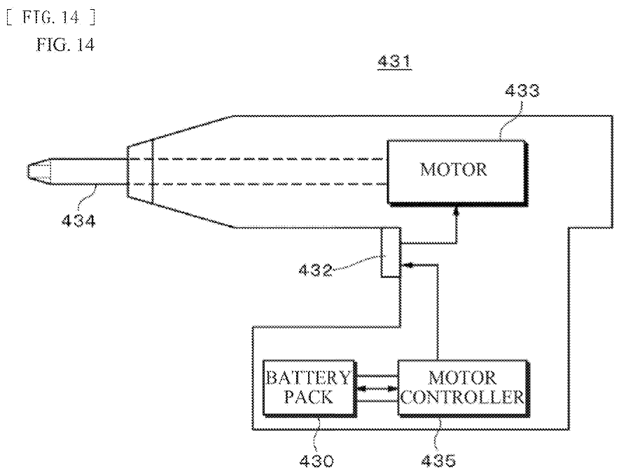

As an example of the electric tools to which the present technology is applicable, an electric screwdriver will be schematically described with reference to FIG. 14. An electric screwdriver 431 includes a motor 433 and a trigger switch 432. The motor 433 transmits rotational power to a shaft 434. The trigger switch 432 is operated by a user. A battery pack 430 and a motor controller 435 are contained in a lower housing of a handle of the electric screwdriver 431. The battery pack 430 is built in or detachably attached to the electric screwdriver 431. The secondary battery according to an embodiment is applicable to a battery included in the battery pack 430.

The battery pack 430 and the motor controller 435 may include respective microcomputers (not illustrated) communicable with each other to transmit and receive charge and discharge data on the battery pack 430. The motor controller 435 controls operation of the motor 433, and is able to cut off power supply to the motor 433 under abnormal conditions such as overdischarging.

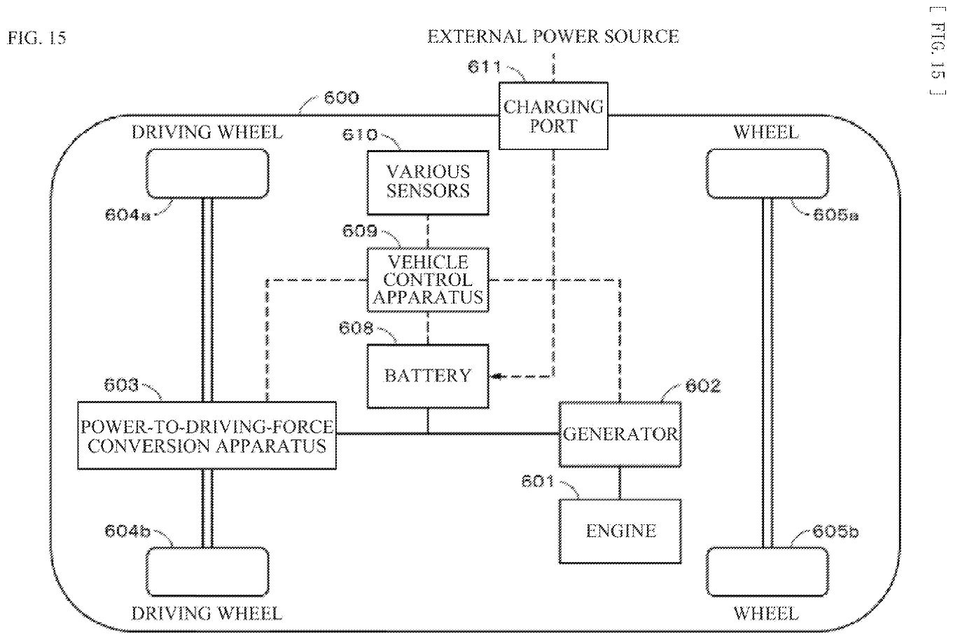

As an example of application of the present technology to a power storage system for electric vehicles, FIG. 15 schematically illustrates a configuration example of a hybrid vehicle (HV) that employs a series hybrid system. The series hybrid system relates to a vehicle that travels with an electric-power-to-driving-force conversion apparatus, using electric power generated by a generator that uses an engine as a power source, or using electric power temporarily stored in a battery.

A hybrid vehicle 600 is equipped with an engine 601, a generator 602, an electric-power-to-driving-force conversion apparatus (a direct-current motor or an alternating-current motor; hereinafter, simply “motor 603”), a driving wheel 604a, a driving wheel 604b, a wheel 605a, a wheel 605b, a battery 608, a vehicle control apparatus 609, various sensors 610, and a charging port 611. The secondary battery according to an embodiment, or a power storage module equipped with a plurality of secondary batteries according to an embodiment is applicable to the battery 608.

The motor 603 operates under the electric power of the battery 608, and a rotational force of the motor 603 is transmitted to the driving wheels 604a and 604b. Electric power generated by the generator 602 using a rotational force generated by the engine 601 is storable in the battery 608. The various sensors 610 control an engine speed via the vehicle control apparatus 609, and control an opening angle of an unillustrated throttle valve.

When the hybrid vehicle 600 is decelerated by an unillustrated brake mechanism, a resistance force at the time of deceleration is applied to the motor 603 as a rotational force, and regenerative electric power generated from the rotational force is stored in the battery 608. In addition, the battery 608 is chargeable by being coupled to an external power source via the charging port 611 of the hybrid vehicle 600. Such an HV vehicle is referred to as a plug-in hybrid vehicle (PHV or PHEV).

Note that the secondary battery according to an embodiment may be applied to a small-sized primary battery and used as a power source of an air pressure sensor system (a tire pressure monitoring system: TPMS) built in the wheels 604 and 605.

Although the series hybrid vehicle has been described herein as an example, the present technology is applicable also to a hybrid vehicle of a parallel system in which an engine and a motor are used in combination, or of a combination of the series system and the parallel system. Furthermore, the technology is applicable to an electric vehicle (EV or BEV) and a fuel cell vehicle (FCV) that travel by means of only a driving motor without using an engine.

### REFERENCE SIGNS LIST

1, 1A: lithium ion battery
12: insulator
21: positive electrode
21A: positive electrode foil
21B: positive electrode active material layer
21C: positive electrode active material uncovered part
22: negative electrode
22A: negative electrode foil
22B: negative electrode active material layer
22C: negative electrode active material uncovered part
22D: innermost wind side negative electrode
23, 23A to 23E: separator
24: positive electrode current collector
25: negative electrode current collector
26: through hole
41, 42: end face
43: groove
221A: first negative electrode active material uncovered part
221B: second negative electrode active material uncovered part
221C: third negative electrode active material uncovered part

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode wound body including a positive electrode having a band shape and a negative electrode having a band shape, the positive electrode and the negative electrode being stacked with a separator interposed therebetween;
a positive electrode current collector;
a negative electrode current collector; and
a battery can containing the electrode wound body, the positive electrode current collector, and the negative electrode current collector, wherein
the positive electrode includes, on a positive electrode foil having a band shape, a positive electrode active material covered part covered with a positive electrode active material layer, and a positive electrode active material uncovered part,
the negative electrode includes, on a negative electrode foil having a band shape, a negative electrode active material covered part covered with a negative electrode active material layer, and a negative electrode active material uncovered part extending at least in a longitudinal direction of the negative electrode foil,
the positive electrode active material uncovered part is coupled to the positive electrode current collector at one of end parts of the electrode wound body,
the negative electrode active material uncovered part is coupled to the negative electrode current collector at another of the end parts of the electrode wound body,
the electrode wound body has one or more flat surfaces, in which the positive electrode active material uncovered part, the negative electrode active material uncovered part, or both are bent toward a central axis of the wound structure to form the one or more flat surfaces, and a groove provided in each of the one or more flat surfaces, and
in at least a positive electrode side of the electrode wound body as viewed in a section taken along a plane including the central axis, respective end parts of layers of the separator that are located at least on respective opposite sides of an innermost wind side negative electrode are coupled to each other, the innermost wind side negative electrode being a part of the negative electrode that is located on a side of an innermost wind.

2. The secondary battery according to claim 1, wherein
the electrode wound body includes multiple layers of the separator at a location on an inner side of the innermost wind side negative electrode, the multiple layers of the separator including one of the layers of the separator whose respective end parts are coupled to each other, and
another one of the layers of the separator which is located on an outer side of the innermost wind side negative electrode and the multiple layers of the separator are coupled to each other at their respective end parts.

3. The secondary battery according to claim 2, wherein
in a negative electrode side of the electrode wound body as viewed in the section, respective end parts of the multiple layers of the separator located on the inner side of the innermost wind side negative electrode are coupled to each other.

4. The secondary battery according to claim 3, wherein the other one of the layers of the separator which is located on the outer side of the innermost wind side negative electrode and the multiple layers of the separator are not coupled to each other.

5. The secondary battery according to claim 1, wherein the coupling comprises coupling by welding or coupling by bonding.

6. The secondary battery according to claim 1, wherein the negative electrode further includes a negative electrode active material uncovered part at an end part in the longitudinal direction on each of a beginning side of winding and an end side of the winding.

7. Electronic equipment comprising the secondary battery according claim 1.

8. An electric tool comprising the secondary battery according to claim 1.
